(19) United States
(12) Patent Application Publication
(10) Pub. No.: US 2005/0127134 A1
(43) Pub. Date: Jun. 16, 2005

(54) Nano-metal composite made by deposition from colloidal suspensions

(76) Inventors: Guo-Quan Lu, Blacksburg, VA (US); Zhiye Zhang, Blacksburg, VA (US); Jesus N. Calata, Blacksburg, VA (US); Guofeng Bai, Blacksburg, VA (US); Yanjing Liu, Blacksburg, VA (US); Bryan Koene, Blacksburg, VA (US); Paige Phillips, Blacksburg, VA (US)

Correspondence Address: WHITHAM, CURTIS & CHRISTOFFERSON, P.C., 11491 SUNSET HILLS ROAD, SUITE 340, RESTON, VA, 20190, US

(21) Appl. No.: 10/941,014

(22) Filed: Sep. 15, 2004

Related U.S. Application Data
(60) Provisional application No. 60/502,611, filed on Sep. 15, 2003.

(51) Int. Cl. B23K 1/00

(52) U.S. Cl. 228/101

(57) ABSTRACT

Methods of attaching high-temperature electrical components to substrates are provided. The methods involve of attachment of high-temperature components to substrates via a nano-metal film.

### CROSS-REFERENCE TO RELATED APPLICATIONS

This application claims benefit of U.S. Provisional Patent Application 60/502,611, filed Sep. 15, 2003, the complete contents of which are hereby incorporated by reference.

### STATEMENT REGARDING FEDERALLY SPONSORED RESEARCH

This invention was made using funds from grants from the Ballistic Missiles Defense Agency STTR Program Contract # AFR-F33615-02-M-2298. The United States government may have certain rights in this invention.

### DESCRIPTION

### BACKGROUND OF THE INVENTION

1. Field of the Invention

The invention generally relates to attaching electrical components such as integrated circuit chips, multilayer devices, and the like to substrates in a manner that assures good electrical and thermal conductivity. More particularly, the invention provides an improved attachment technology for securing high temperature components to substrates which provides for improved electrical and thermal conductivity.

2. Background of the Invention

The development of high-temperature electronic components, such as SiC devices, permits elimination of cumbersome cooling systems in electronic packages and modules. In order to fasten such high-temperature components to substrates, a connecting layer capable of high-temperature operation and having good electrical conductivity, thermal conductivity and adhesion properties is required. Existing methods of attachment use alloys with very low melting points such as eutectic lead-tin, which melts at 183° C., or polymer adhesives filled with metal particles such as silver-filled epoxy. Because of the low melting temperature of such alloys and/or low decomposition temperature of polymers, they are not capable of high-temperature operation.

Non-solder and/or polymer adhesives materials capable of high-temperature operation are available. However, known methods of attaching such materials require a very high temperature (e.g. 600° C.), and such high processing temperatures can be detrimental to the intricate structures in the electronic components being attached (e.g. transistors and capacitors). As an alternative, attachment may be assisted with externally applied pressure. For example, pressure-assisted sintering uses a metal paste to fasten electronic components. The metal paste is made of metal powder and a polymer binding system. However, the metal powder typically has a relatively large particle size (in the micrometer range), and thus still requires high sintering temperatures, and the application of high pressure can crack and damage the components that are being attached.

The prior art has thus far failed to provide a method of attaching high-temperature components to substrates that succeeds in providing a connecting layer with good electrical conductivity, thermal conductivity, and attachment properties, and yet which does not require processing at high temperature and/or high pressure in order carry out attachment.

### SUMMARY OF THE INVENTION

The present invention provides methods to attach high-temperature devices and components to substrates without using high-temperatures or externally applied pressure during the attachment process. The method involves the use of a nano-metal film or layer for attachment. The nano-metal layer is formed between the substrate and component by deposition of a nano-metal composite that contains nano-metal particles and long-chain polymers. The nano-metal particles in the composite preferably range in size between about 1 to about 100 nm prior to sintering. After the composite is deposited, sintering and burnout of the long-chain polymer component of the composite leaves behind a nano-metal connecting layer between the substrate and component, which serves to attach the component to the substrate. The nano-metal layer displays good adhesion properties, and permits good electrical and thermal conductivity between the component and the substrate.

It is an object of the invention to provide a method for attaching an electrical component to a substrate. The method comprises a first step of positioning a film comprised of conductive particles and polymeric material to attach the electrical component to the substrate. The conductive particles, which have an average diameter less than about 100 nm, are dispersed within the polymeric material. The method further comprises a step of sintering the film to remove at least a major portion of the polymeric material from the film, and to sinter together at least a plurality of the conductive particles. The sintering step produces a sintered conductive layer from the film that electrically and thermally connects the electrical component and the substrate. The positioning step may include a step of forming the film on at least one or two surfaces of the electrical component, the substrate, or both. In one embodiment, an additional step of patterning the film is included. Patterning may be performed prior to or after the forming step.

The conductive particles themselves are selected from silver, gold, copper, palladium, tin, tungsten, titanium, chromium, vanadium, aluminum, and alloys thereof. The polymeric material includes ionic polymers including but not limited to poly(diallyldimethylammonium chloride (PDAA), polyacrylic acid (PAA), poly (allylamine hydrochloride) (PAH), poly(4-styrenesulfonic acid), poly(vinyl sulfate) potassium salt, 4-styrenesulfonic acid sodium salt hydrate, polystyrene sulfonate (PSS), polyethylene imine (PEI), etc. One embodiment of the invention, further includes a step of degrading the polymeric material prior to the sintering step by exposing the film to radiant energy, for example, to ultraviolet light or to microwave radiation. In another embodiment, the invention further includes a step of degrading the polymeric material prior to the sintering step by exposing the film to thermal energy.

The invention further provides an electronic device that comprises an electrical component; a substrate; and a film comprised of conductive particles and polymeric material. The film attaches the electrical component to the substrate. The conductive particles are dispersed within the polymeric material, and are of a size that is no more than about 100 nm on average. In one embodiment of the invention, the conductive particles are silver or silver alloy.

The invention further provides an electronic device that comprises an electrical component; a substrate; and a sintered conductive layer that electrically and thermally connects the electrical component and the substrate. The sintered conductive layer is formed from a film comprised of conductive particles and polymeric material. The film attaches the electrical component to the substrate. The conductive particles are dispersed within the polymeric material, and are of a size that is no more than about 100 nm on average. The film is sintered to remove at least a major portion of the polymeric material from the film, and to sinter together at least a plurality of the conductive particles. In one embodiment of the device, the conductive particles are silver or silver alloy.

The invention also provides a method for attaching an electrical component to a substrate. The method comprises a first step of positioning a film comprised of charged conductive particles associated with at least a first oligomeric or polymeric material to attach the electrical component to the substrate; and a second step of sintering the film to remove at least a major portion of the first oligomeric or polymeric material from the film, and to sinter together at least a plurality of the conductive particles. The sintering step produces a sintered conductive layer from the film that electrically and thermally connects the electrical component and the substrate.

In one embodiment, the film comprises a second oligomeric or polymeric material. In this embodiment, the first oligomeric or polymeric material is oppositely charged with respect to the charged conductive particles, and the second oligomeric or polymeric material is oppositely charged with respect to the first oligomeric polymeric material. In one variation of this embodiment, the charged conductive particles and the second oligomeric or polymeric material are both positively charged. In another variation of this embodiment, the charged conductive particles and the second oligomeric or polymeric material are both negatively charged. Another variation is that mixtures of charged nanoparticles and charged oligomer or polymer are co-deposited.

The positioning step of the method may further include a step of forming the film on at least one or two surfaces of the electrical component and said substrate, or both. In one embodiment, an additional step of patterning the film is included. Patterning may be performed prior to or after the forming step.

In one embodiment of the method, the forming step is performed by depositing multiple layers of the charged conductive particles and the first oligomeric or polymeric material by electrostatic deposition.

In yet another embodiment, the film comprises a second oligomeric or polymeric material. The first oligomeric or polymeric material is oppositely charged with respect to the charged conductive particles, and the second oligomeric or polymeric material is oppositely charged with respect to the first oligomeric polymeric material. In this embodiment, the forming step is performed by electrostatic deposition of multiple alternating layers of the conductive charged particles associated with the first oligomeric or polymeric material, and the second oligomeric or polymeric material.

In this method, the charged conductive particles are, on average, smaller than about 100 nm in diameter and are most preferably smaller than about 20 nm in diameter, and are made from material selected from but not limited to silver, gold, copper, palladium, tin, tungsten, titanium, chromium, vanadium, aluminum, and alloys thereof, or other conductive substrates. The polymeric material may include poly(diallyldimethylammonium chloride (PDAA), polyacrylic acid (PAA), poly (allylamine hydrochloride) (PAH), poly(4-styrenesulfonic acid), poly(vinyl sulfate) potassium salt, 4-styrenesulfonic acid sodium salt hydrate, polystyrene, sulfonate (PSS), polyethylene imine (PEI), etc. A further embodiment of this method includes a step of degrading the polymeric material prior to the sintering step by exposing the film to radiant energy, for example, to ultraviolet light or to microwave radiation. In another embodiment, the method further includes a step of degrading the polymeric material prior to the sintering step by exposing the film to thermal energy.

The invention further provides an electronic device that comprises an electrical component; a substrate; and a film comprised of charged conductive particles associated with at least a first oligomeric or polymeric material that attaches the electrical component to the substrate. In one embodiment, the film comprises at least a second oligomeric or polymeric material, wherein the first oligomeric or polymeric material is oppositely charged with respect to the charged conductive particles, and the second oligomeric or polymeric material is oppositely charged with respect to the first oligomeric polymeric material. The charged conductive particles may be of a size that is no more than about 100 nm on average.

The invention further provides an electronic device that comprises an electrical component; a substrate; and a sintered conductive layer that electrically and thermally connects the electrical component and the substrate. The sintered conductive layer is formed from a film comprised of charged conductive particles associated with at least a first oligomeric or polymeric material. The film is sintered to remove at least a major portion of the first oligomeric or polymeric material from the film, and to sinter together at least a plurality of the charged conductive particles.

### BRIEF DESCRIPTION OF THE DRAWINGS

FIG. 1A-D shows schematic side views of: A, a nano-metal composite film 10 on a substrate 20; B, a nano-metal composite film 10 on a high temperature component 30; C, nano-metal composite films 10 on both sides of a metal foil 40; and D, schematic of a nano-metal composite film 10, substrate 20, and high temperature component 30 showing attachment via sintering (represented by arrow).

FIG. 2A-D shows A, deposition of positively charged polymers 12 (heavy black lines) on substrate 11; B, deposition of negatively charged metal ion-polymer complexes 13 (with negatively charged polymers are light gray lines) to form a bilayer 16; C, two bilayers 16; D, enlarged view of a metal ion-polymer complex 13 showing metal particle 14 and attached negatively charged polymers 15 light gray lines).

FIG. 3A-B shows a schematic depiction of bilayer 16 positioned between substrate 20 and component 30 subjected to polymer degradation (arrow).

### DETAILED DESCRIPTION OF THE PREFERRED EMBODIMENTS OF THE INVENTION

The present invention provides methods to attach high-temperature electrical components and devices to substrates without using high-temperatures or externally applied pressure during the attachment process. The method involves the use of a nano-metal composite film between the substrate and component, burnout of the long-chain polymer component of the composite, and sintering, which leaves a nano-metal connecting layer with good electrical conductivity, thermal conductivity and attachment properties between the component and the substrate. Practice of the present invention thus allows attachment of a component at relatively low temperatures and low or no pressure, thereby lessening the risk of damage to the component, and yet the connection is capable of withstanding high temperatures generated during operation of the electrical component. The attachments formed by the methods of the present invention exhibit higher electrical, thermal and mechanical properties than solder-based die-attach interconnection materials, and in general have properties comparable or superior to those of attachments made by pressure-assisted sintering of micrometer size particles. Practice of the present invention allows the elimination of large heat sinks or other complicated and expensive cooling mechanisms that are otherwise necessary for the proper operation of electronic components attached with prior art low-temperature methods. Such improvements result in significantly lower manufacturing and operating costs.

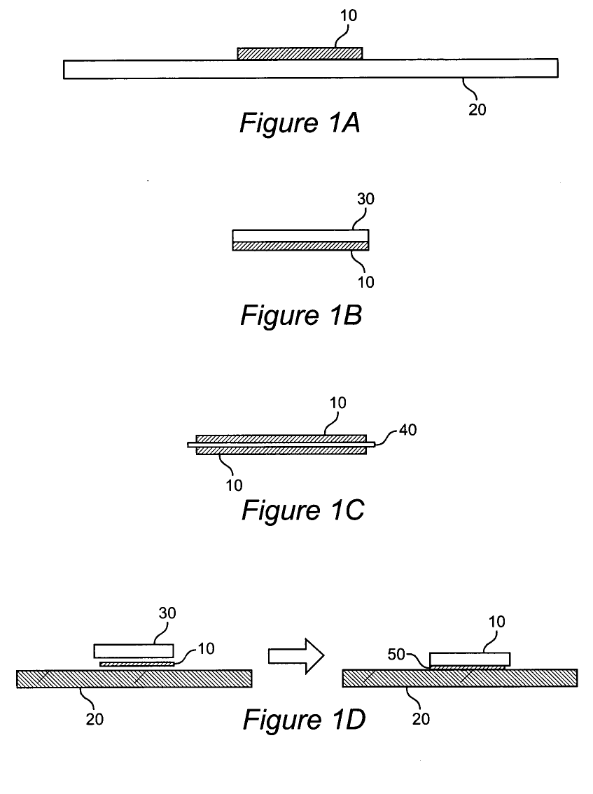

The method of the present invention involves positioning a layer or film of a nano-metal composite on the surface of the substrate to which the high-temperature component is to be attached, or to the surface of the component that is to be adhered to the substrate, or both. Alternatively, the nano-metal composite film may be positioned on both sides of a metal foil, and the substrate and the component are attached to each other via the intervening metal foil. In the preferred embodiment, the nanometal composite film is formed directly on a surface of the electrical component or substrate. However, alternative methods of positioning the film on the substrate or component might be used, for example, applying the nanometal layer as a tape, etc. Certain of these alternatives are depicted schematically in FIGS. 1A-D, which show: (1A), a layer of nano-metal composite 10 formed on substrate 20; (1B), a layer of nano-metal composite 10 formed on component 30; and (1C), layers of nano-metal composite 10 formed on both sides of a metal foil 40. In addition, the metal film can be deposited selectively by physically masking (patterning) the substrate so that only the area on which it is desired to deposit the film is exposed. Patterning may be carried out either before or after depositing the film. Whichever method is chosen, the component is attached to the substrate and the nanometal composite is between the substrate and component as shown in FIG. 1D which shows component 30, substrate 20 and metal layer 10, and in which the arrow represents the sintering process. At the left of the arrow in FIG. 1D, the composite layer is shown between but unattached to the substrate or component for clarity. As a result of sintering, nanometal layer 50 is formed between component 30 and substrate 20 as seen at the right of the arrow, where component 30 is shown as directly attached to substrate 20 via intervening nanometal layer 50.

The substrate onto which the metal ion composite is deposited may be any suitable type of substrate, examples of which include but are not limited to printed circuit boards, silicon substrates, silicon and/or silicon dioxide materials, silicon carbide, germanium, direct-bonded-copper (DBC) substrate, and high-temperature substrates, etc. Such substrates may be formed from any suitable material, many of which are known to those of skill in the art. Examples include but are not limited to silicon, silicon carbide, germanium, copper and high-temperature polymers, etc. Likewise, the components that are attached to the substrate may be any component of interest, examples of which include but are not limited to transistors, capacitors, integrated circuits, diodes, inductors, modules, sensors, or other electronic components requiring conductive interconnection, etc. While in a preferred embodiment, the component that is attached is a high-temperature electrical component or device, those of skill in the art will recognize that this need not be the case. Low-temperature electrical or other types of components may equally well be attached by the practice of the methods of the present invention.

The nano-metal composite of the invention is a layered metal ion-polymer complex preferably comprising positively charged metal ion clusters or particles, negatively charged long-chain polymer molecules associated with the metal particles, and positively charged long-chain polymer molecules which form alternating layers with the metal ion-negatively charged long-chain polymer component. The metal particles range in size up to about no more than about 100 nm on average. Preferred sizes are from about 20 to about 100 nm on average. Other preferred sizes are about 1 to about 30 nm.

Those of skill in the art will recognize that many metals may be used to generate the nano-metal particles that are used in the practice of the present invention. For example, silver, gold, copper, palladium, tin, tungsten, titanium, chromium, vanadium, aluminum, indium, and other metallic atoms found in the periodic table of elements, and alloys thereof may be utilized. In a preferred embodiment of the invention, the metal is silver.

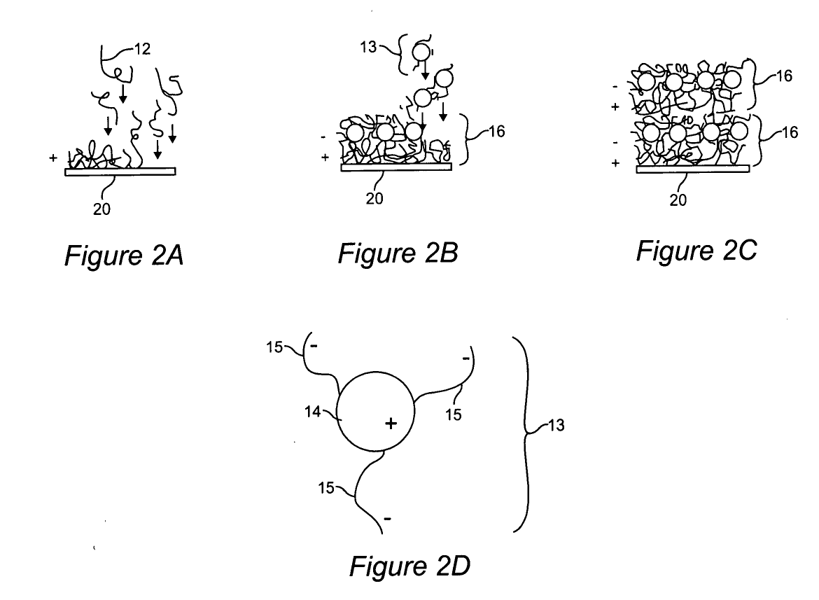

A metal-bearing polymer solution can be prepared by chemically reducing positively charged metal ions in a solution of negatively charged polymers. This results in a polymer-metal nanoparticle pairing in which the polymer serves as a “carrier” for the metal to be incorporated into a layered, electrostatically deposited film. The negatively charged long chain polymers are associated with the metal clusters via ionic bonding. The negatively charged polymers are associated principally at the surface of the metal cluster and surround (protect) the metal cluster. Thus the surface of the metal ion-polymer complex bears a negative charge. This is illustrated in FIG. 2D, where circle 14 represents a positively charged metal ion particle or cluster and 15 represents negatively charged long-chain polymers (shown as light gray lines) ionically bonded to the exterior of the metal ion particle. Thus, complex 13 has an overall negative charge on its exterior. Those of skill in the art will recognize that many negatively charged long-chain polymers are known that may be utilized in this manner, examples of which include but are not limited to polyacrylic acid (sodium salt) (PAA); poly (4-styrenesulfonic acid); poly(vinyl sulfate) potassium salt, 4-styrenesulfonic acid sodium salt, etc.

The nano-metal complexes may be deposited by any of several nano-size thin film growth techniques that are known to those of skill in the art, including but not limited to wet and dry electrostatic deposition, layer-by-layer self assembling techniques, dry electrostatic printing, etc. Another variation includes the preparation of a metal-bearing polymer solution with a cationic polymer such as, but not limited to, polyallylamine hydrochloride (PAH), poly (ethyleneimine) (PEI), poly(diallydimethylammoniumn chloride) (PDDA), and the like. Another variation includes the preparation of a metal bearing polymer solution in the absence of a polymer. Details of there procedures can be found for example, in [Helmut Bonnemann and Ryan M. Richards “Nanoscopic Metal Particles-Synthetic Methods and Potential Applications”. Eur. J Inorg. Chem. (2001), p. 2455.] or in [Colloids in colloid assemblies: Synthesis, Modification, Organization, and Utilization of Colloid Particles, 3^{rd} edition, Editor Frank Caruso, 13 Jan. 2004]. In a preferred embodiment of the invention, deposition occurs by electrostatic deposition from colloidal suspensions, the details of which are readily available and known to those of skill in the art, as found in, for example, Further details of such techniques may be found, for example, in [Yanjing Liu, Youxiong Wang, and Richard O. Claus, “Layer-by-layer ionic self-assembly of Au colloids into multiplayer thin films with bulk metal conductivity”, Chem. Phys. Lett. 298 (1998) p. 315]. Briefly, a surface of a substrate on which deposition is to occur is sequentially exposed to a series of colloidal suspensions of charged polymers (or oligomers) or polymer (or oligomer)-metal ion complexes or metal nanoparticles. The process of exposure is referred to as “dipping”, and may include steps of washing in between exposure to colloidal suspensions to remove unbound material. In one embodiment, positively charged polymers are alternately dipped with negatively charged polymer/metal colloid solutions.

This process is illustrated in FIGS. 2A-C, which show in panel A the deposition of a layer of positively charged polymers 12 (shown as heavy black lines) onto the surface of substrate 20. Many such positively charged polymers are known and may be used in the practice of the present invention, for example, poly(allylamine hydrochloride) (PAA), polyallylamine hydrochloride (PAH), poly(ethylene imine) (PEI), poly(4-styrenesulfonic acid), poly(vinyl sulfate) potassium salt and 4-styrenesulfonic acid sodium salt hydrate, poly(diallyldimethylammonium chloride) (PDDA), and the like. In a preferred embodiment of the invention, the polymers are PAA and PDDA. The substrate is exposed to the solution of negatively charged polymers for approximately 1-10 minutes, and preferably about 2 minutes, or until a layer approximately about 0.5 to about 20 nm thick is formed The substrate is then removed from contact with the solution of positively charged polymers, and is exposed to a colloidal suspension of metal ion-negatively charged polymer complexes (13 in FIG. 2B). A negatively charged layer of complexes 13 (where the negatively charged polymers that are associated with the metal are shown as light gray lines and the metal is shown as a circle) is deposited onto the layer of positively charged polymers, forming a bilayer, 16 in FIG. 2B. Negatively charged complexes are deposited to a depth of about 20 nm. The substrate is then withdrawn from contact with the colloidal suspension, and the entire process is repeated to form one or more additional, consecutive bilayers, as shown in FIG. 2C, where two bilayers 16 are illustrated. Typically, bilayers will be sequentially deposited until the total depth of deposited material is in the range of about 2 to about 20 micrometers, and preferably is at least about 2 micrometers, which corresponds to about 100 to about 1000 total bilayers. In general, the final layer that is deposited may be either negatively or positively charged, depending on the application.

Another variation would be deposition of a film by alternately depositing negatively charged polymers with positively charged polymer/metal colloid solution prepared in the same way. Another variation would by the deposition of a film by the alternate deposition of a charged metal colloid solution with the complementary charged polymer solution.

As indicated earlier, the nano-metal composite may be deposited onto the substrate, onto the component that is to be attached to the substrate, onto both the substrate and the component, or onto both sides of a metal foil the will be positioned between the substrate and component. In any case, the substrate, component and metal layer must be suitably juxtaposed in preparation for sintering according to known electrostatic deposition theory and practice.

Sintering is the process whereby the metal particles are heated and made to cohere to one another, forming a continuous metallic film between the substrate and component. In order for metal cohesion to occur properly, the long-chain polymers that were deposited along with metal ions must be degraded and removed to as great an extent as is practically possible. When extremely high temperatures are used for sintering (as in prior art methods) the high temperatures cause polymer degradation, a process known as “burnout”. In the methods of the present invention, relatively low temperatures are used for sintering. Therefore, it is advantageous to use additional, auxiliary methodologies to bring about polymer degradation and removal.

One method of polymer/oligomer degradation is to expose the film to radiant energy. In one embodiment of the present invention, the metal ion-polymer bilayers are exposed to ultraviolet (UV) light prior to sintering in order to degrade the polymer chains. Those of skill in the art will recognize that the amount of UV light required to degrade the polymer chains and the length of exposure to the UV light will vary depending on several factors, including the type of polymer, the thickness of the layers, the degree of degradation desired, nature of the atmosphere (e.g. air, oxygen, nitrogen, vacuum, etc.), and the like. In general, the amount of UV light required to obtain adequate degradation can be determined by standard thermal testing methods such as thermal gravimetric analysis (TGA) and, as will be recognized by those of skill in the art, will vary depending on the polymer that is used.

In another embodiment of the invention, microwave energy is used to bring about polymer chain degradation. Microwaves are known to provide an exceptionally even distribution of heat within a targeted substance, and thus provide uniform degradation of polymer chains within multiple bilayers of any thickness. As is the case with UV light, the amount of microwave energy and the length of exposure to microwave energy will vary from application to application. However, in general the amount of microwave required to obtain adequate degradation can be determined by standard thermal testing methods such as thermal gravimetric analysis (TGA) and, as will be recognized by those of skill in the art, will vary depending on the polymer that is used.

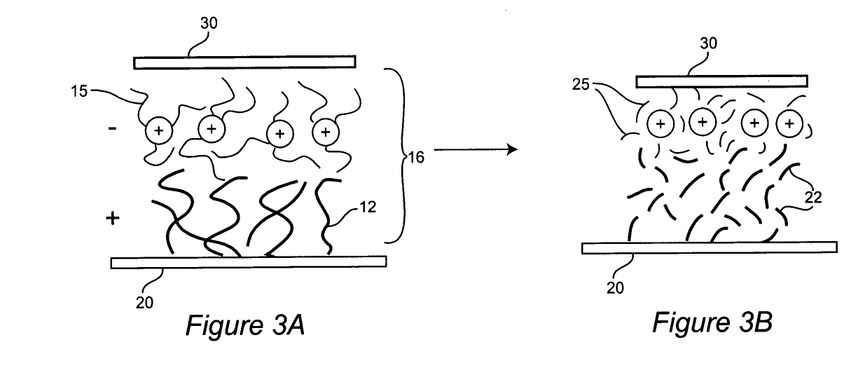

In yet another embodiment of the invention, exposure to UV light and exposure to microwave energy may both used to degrade polymer chains, exposure to the two different energy forms being consecutive and in either order, i.e. first UV, then microwave or first microwave, then UV. It should also be understood that while sintering temperatures used in the practice of the present invention are relatively low compared to prior art techniques, they are still high enough to also promote some degradation and removal of polymer chains by the thermal energy of sintering. The process of polymer degradation is illustrated in FIG. 3A and B, where panel A depicts a schematic representation of single bilayer 16 positioned between substrate 20 and component 30. Positively charged polymers 12 and negatively charged polymers 15 are converted into degradation products 22 and 25 by the application of radiant or thermal energy, represented by the arrow. Degradation products are ultimately removed from the film chiefly by evaporation.

Polymer chain degradation is carried out to the extent that a major portion of the oligomeric or polymeric material is removed, i.e. until metal particle are able to bond to one another so that the resultant interconnect attains an electrical conductivity equal to that of the metal used. Conductivity measurements can be made via probe measurements understood by those skilled in the art. The content of residual polymer left after sintering can be determined by thermal gravimetric analysis (TGA). Once polymer chain degradation has been carried out, sintering is carried out. The choice of sintering conditions [e.g. temperature, heating time, heating rate, atmosphere (e.g. air, nitrogen, vacuum, etc.)] will depend on the nature of the substrate, component, and metal ion composite used. However, in general, temperatures used for sintering in the practice of the present invention will be in the range of from about 200 to about 350° C., and the duration of heating time will be in the range of about 2 to about 60 minutes, and preferably from about 5 to about 30 minutes, or until a relative density of the metal particles of about 70% to about 90% is achieved. Electrical conductivity and mechanical strength of the bond are the ultimate quantitative tests as to sintering efficiency. Besides those, microscopy, such as scanning electron microscopy, can be used as a qualitative guide as to the effect of sintering. As will be recognized by those of skill in the art, these conditions are significantly less harsh and less potentially damaging to the component being attached than are typical prior art sintering conditions.

The present invention also provides an electronic device that includes an electrical component, a substrate, and a sintered conductive layer that electrically and thermally connects the electrical component to the substrate. The sintered conductive layer is formed from a film comprised of conductive particles and polymeric material. The film attaches the electrical component to the substrate. The conductive particles are dispersed within the polymeric material and are of a maximum size of about 100 nm or less on average. The film is sintered to remove at least a major portion of the polymeric material from the film, and to sinter together at least a plurality of the conductive particles. A further type of electronic device is provided in which the film is comprised of charged conductive particle associated with at least a first oligomeric or polymeric material which attaches the electrical component to the substrate, and which may further include a second oligomeric/polymeric material. The first material bears a charge opposite to that of the charged conductive particles, and the second material bears a charge that is opposite that of the first material.

### EXAMPLES

### Example 1

A conductive silver film connecting a component to a substrate was produced using layer by layer electrostatic deposition from colloidal suspension. The 10 to 30 nm silver particles were protected by a negative polymer, polyacrylic acid (sodium salt, PAA). PAA was applied as negative suspension of silver ions coated with PAA. Poly(diallyldimethylammonium chloride) (PDDA) was used as a positive suspension. The weight concentration of silver in the final deposited film was about 60%; the weight concentration of positive polymer PAA was about 19%, and the weight concentration of the negative polymer PDDA was about 21%.

The film was sintered at 350° C. in order to degrade the polymer chains and to obtain a dense, cohesive silver film. Scanning electron microscopy (SEM) was used to analyze the film before and after sintering. The SEM results showed the film deposited on Si substrate before sintering appeared as silver nano particles. After, sintering, SEM results showed the film to be a continuous, cohesive silver film.

While the invention has been described in terms of its preferred embodiments, those skilled in the art will recognize that the invention can be practiced with modification within the spirit and scope of the appended claims. Accordingly, the present invention should not be limited to the embodiments as described above, but should further include all modifications and equivalents thereof within the spirit and scope of the description provided herein.

1. A method for attaching an electrical component to a substrate, comprising the steps of:
positioning a film comprised of conductive particles and polymeric material to attach said electrical component to said substrate, said conductive particles being dispersed within said polymeric material, and being of a size which is no more than 100 nm on average; and
sintering said film to remove at least a major portion of said polymeric material from said film, and to sinter together at least a plurality of said conductive particles, said sintering step producing a sintered conductive layer from said film which electrically and thermally connects said electrical component and said substrate.

2. The method of claim 1 wherein said positioning step includes the step of forming said film on at least one surface of at least one of said electrical component and said substrate.

3. The method of claim 2 wherein said forming step includes the step of forming said film on at least two surfaces of at least one of said electrical component and said substrate.

4. The method of claim 2 further comprising the step of patterning said film.

5. The method of claim 4 wherein said patterning step is performed prior to said forming step.

6. The method of claim 4 wherein said patterning step is performed after said forming step.

7. The method of claim 1 wherein said conductive particles are selected from the group consisting of silver, gold, copper, palladium, tin, tungsten, titanium, chromium, vanadium, aluminum, and alloys thereof.

8. The method of claim 1 wherein said polymeric material includes PDDA and PAA.

9. The method of claim 1 further comprising the step of degrading said polymeric material prior to said sintering step by exposing said film to radiant energy.

10. The method of claim 9 wherein said radiant energy is ultraviolet light.

11. The method of claim 9 wherein said radiant energy is microwave radiation.

12. The method of claim 1 further comprising the step of degrading said polymeric material prior to said sintering step by exposing said film to thermal energy.

13. An electronic device, comprising:
an electrical component;
a substrate; and
a film comprised of conductive particles and polymeric material, said film attaches said electrical component to said substrate, said conductive particles being dispersed within said polymeric material, and being of a size which is no more than 100 nm on average.

14. The electronic device of claim 13 wherein said conductive particles are silver or silver alloy.

15. An electronic device, comprising an electrical component;
a substrate; and
a sintered conductive layer which electrically and thermally connects said electrical component and said substrate, said sintered conductive layer being formed from a film comprised of conductive particles and polymeric material, said film attaches said electrical component to said substrate, said conductive particles being dispersed within said polymeric material, and being of a size which is no more than 100 nm on average, wherein said film is sintered to remove at least a major portion of said polymeric material from said film, and to sinter together at least a plurality of said conductive particles.

16. The electronic device of claim 15 wherein said conductive particles are silver or silver alloy.

17. A method for attaching an electrical component to a substrate, comprising the steps of:
positioning a film comprised of charged conductive particles associated with at least a first oligomeric or polymeric material to attach said electrical component to said substrate; and sintering said film to remove at least a major portion of said first oligomeric or polymeric material from said film, and to sinter together at least a plurality of said conductive particles, said sintering step producing a sintered conductive layer from said film which electrically and thermally connects said electrical component and said substrate.

18. The method of claim 17 wherein said film comprises a second oligomeric or polymeric material, wherein
said first oligomeric or polymeric material is oppositely charged with respect to said charged conductive particles, and
said second oligomeric or polymeric material is oppositely charged with respect to said first oligomeric polymeric material.

19. The method of claim 18 wherein said charged conductive particles and said second oligomeric or polymeric material are both positively charged.

20. The method of claim 18 wherein said charged conductive particles and said second oligomeric or polymeric material are both negatively charged.

21. The method of claim 17 wherein said positioning step includes the step of forming said film on at least one surface of at least one of said electrical component and said substrate.

22. The method of claim 21 wherein said forming step includes the step of forming said film on at least two surfaces of at least one of said electrical component and said substrate.

23. The method of claim 21 further comprising the step of patterning said film.

24. The method of claim 23 wherein said patterning step is performed prior to said forming step.

25. The method of claim 23 wherein said patterning step is performed after said forming step.

26. The method of claim 21 wherein said forming step is performed by depositing multiple layers of said charged conductive particles and said at least a first oligomeric or polymeric material by electrostatic deposition.

27. The method of claim 21 wherein said film comprises a second oligomeric or polymeric material, wherein
said first oligomeric or polymeric material is oppositely charged with respect to said charged conductive particles, and
said second oligomeric or polymeric material is oppositely charged with respect to said first oligomeric polymeric material; and
wherein said forming step is performed by electrostatic deposition of multiple alternating layers of said conductive charged particles associated with said first oligomeric or polymeric material, and said second oligomeric or polymeric material.

28. The method of claim 17 wherein said charged conductive particles are, on average, smaller than 100 nm in diameter.

29. The method of claim 17 wherein said conductive particles are selected from the group consisting of silver, gold, copper, palladium, tin, tungsten, titanium, chromium, vanadium, aluminum, and alloys thereof.

30. The method of claim 17 wherein said polymeric material includes PDDA and PAA.

31. The method of claim 17 further comprising the step of degrading said polymeric material prior to said sintering step by exposing said film to radiant energy.

32. The method of claim 31 wherein said radiant energy is ultraviolet light.

33. The method of claim 31 wherein said radiant energy is microwave radiation.

34. The method of claim 17 further comprising the step of degrading said polymeric material prior to said sintering step by exposing said film to thermal energy.

35. An electronic device, comprising:
an electrical component;
a substrate; and
a film comprised of charged conductive particles associated with at least a first oligomeric or polymeric material which attaches said electrical component to said substrate.

36. The electronic device of claim 35 wherein said film comprises at least a second oligomeric or polymeric material, wherein
said first oligomeric or polymeric material is oppositely charged with respect to said charged conductive particles, and
said second oligomeric or polymeric material is oppositely charged with respect to said first oligomeric polymeric material.

37. The electronic device of claim 35 wherein said charged conductive particles are of a size that is no more than 100 nm on average.

38. An electronic device, comprising:
an electrical component;
a substrate; and
a sintered conductive layer which electrically and thermally connects said electrical component and said substrate, said sintered conductive layer being formed from a film comprised of charged conductive particles associated with at least a first oligomeric or polymeric material, wherein said film is sintered to remove at least a major portion of said first oligomeric or polymeric material from said film, and to sinter together at least a plurality of said charged conductive particles.
